(19) United States
(12) Patent Application Publication
(10) Pub. No.: US 2009/0257734 A1
(43) Pub. Date: Oct. 15, 2009

(54) ON-VEHICLE VIDEO PLAYBACK APPARATUS

(75) Inventors: Masaru Kimura, Iwaki-city (JP); Shigeru Kohno, Iwaki-city (JP)

Correspondence Address: ALPINE/BHGL, P.O. Box 10395, Chicago, IL, 60610, US

(73) Assignee: Alpine Electronics, Inc., Shinagawa-ku (JP)

(21) Appl. No.: 12/404,695

(22) Filed: Mar. 16, 2009

(30) Foreign Application Priority Data
Apr. 10, 2008 (JP) 2008-102201

(51) Int. Cl. H04N 5/91; H04N 5/00

(52) U.S. Cl. 386/95; 386/126; 386/E05.042; 386/E05.003

(57) ABSTRACT

Provided is an on-vehicle video playback apparatus, which facilitates appropriate playback of contents on a WAN which have to be played back synchronously with contents recorded on a video disc.

In a case where a vehicle is traveling in an area where the connection between on-vehicle DVD player and a WAN via a wireless base station can be established, each network file which involves possibility to be used for playback of a DVD is precedently and sequentially downloaded from a network server and stored in the DVD player. In a case where a vehicle is traveling in an area where the connection with the WAN can not be established, played back is the network file which has already been downloaded and stored when a new network file becomes a playback object.

### RELATED APPLICATIONS

The present application claims priority to Japanese Patent Application Number 2008-102201, filed Apr. 10, 2008, the entirety of which is hereby incorporated by reference.

### BACKGROUND

1. Field of the Invention

The present invention relates to an on-vehicle video playback apparatus for playing back a video disc.

2. Description of the Related Art

A video playback apparatus is known, which downloads contents on a WAN such as the Internet and plays back the downloaded contents synchronously with contents recorded on a video disc, based on playback control information recorded on the video disc (for example, Japanese Patent Application Publication No. 2006-073187).

Further, a technique for downloading and playing back contents through radio communication is known, which accelerating downloading speed of contents being download, in a case where an area where radio communication can not be established such as a tunnel is detected ahead, in order to obtain as much data which is to be played back in the area as possible.

An on-vehicle video playback apparatus according to Japanese Patent Application Publication No. 2006-073187, for example, has the following problems for downloading contents on a WAN like the Internet to play back the downloaded contents synchronously with contents recorded on a video disc based on playback control information recorded on the video disc.

More specifically, as to the on-vehicle video playback apparatus, connection between a WAN through radio communication means that the contents on the WAN cannot be downloaded when the vehicle is outside of an area where radio communication can be established.

In this case, the technique disclosed in Japanese Patent Application Publication No. 2004-193995 appears to be preferable for appropriate downloading of contents, but the other contents on the WAN cannot be downloaded.

Accordingly, it is an object of the present embodiments to facilitate appropriate playback of contents on a WAN in a case where a vehicle is outside of an area where connection with the WAN through radio communication can be established, in an on-vehicle video playback apparatus for downloading contents on a WAN like the Internet based on playback control information recorded on a video disc to play back the downloaded contents synchronously with the contents recorded on the video disc.

### BRIEF SUMMARY

The present embodiments provide an on-vehicle video playback apparatus for playing back a video disc, the on-vehicle video playback apparatus comprises a WAN connection section which is connected to a WAN through radio communication, and a playback section for playing back contents on the WAN together with contents recorded on the video disc based on playback control information recorded on the video disc. The playback section has an on-WAN contents list creation section for creating, at a time of loading the video disc, a list of which contents on the WAN, which are to be played back by the playback section at a time of video disc playback based on the playback control information recorded on the video disc, are registered; and a download processing section which is connected to the WAN in a period when the WAN connection section can be connected to the WAN, and sequentially downloads and stores each of the registered contents on the WAN identified in the list. The playback section plays back contents on the WAN being playback objects based on the playback control information recorded on the video disc, after the contents have already been downloaded and stored by the download processing section.

According to such an on-vehicle playback apparatus, each of the contents on the WAN which involves possibility to be played back at the time of video disc playback is sequentially and preferentially downloaded and stored in a period of connection with the WAN can be established, regardless of timings for play back processing of the contents. Therefore, the precedently stored contents enables appropriate playback of each of the contents on a WAN even in a case where a vehicle is outside of an area where connection with the WAN can be established, and contents on a WAN can be appropriately played back in an improved percentage.

In order to achieve the object described above, in an on-vehicle video playback system according to the present embodiments comprising an on-vehicle video playback apparatus for playing back a video disc and a stationary-type contents obtainment proxy apparatus which can be connected to a WAN, the on-vehicle video playback apparatus has a short range radio communication section which is connected to the contents obtainment proxy apparatus through short range radio communication, and a playback section for playing back contents on the WAN together with contents recorded on the video disc based on playback control information recorded on the video disc. The playback section has an on-WAN contents list creation section for creating, at a time of loading the video disc, a list in which contents on the WAN to be played back by the playback section at a time of video disc playback based on the playback control information recorded on the video disc are registered, an obtainment requesting proxy section which is connected to the contents obtainment proxy apparatus and transmits to the contents obtainment proxy apparatus a proxy obtainment request for contents on the WAN containing the list, in a period when the short range radio communication section can be connected to the contents obtainment proxy apparatus, and a contents storage section, which is connected to the contents obtainment proxy apparatus, for receiving and storing contents on the WAN obtained and forwarded by the contents obtainment proxy apparatus, in a period when the short range radio communication section can be connected to the contents obtainment proxy apparatus. The contents obtainment proxy apparatus has an obtainment proxy section for sequentially downloading and storing contents on the WAN registered in the list along with the proxy obtainment request from the connected on-vehicle video playback apparatus, a contents forwarding section for forwarding contents stored by the obtainment proxy section to the connected on-vehicle video playback apparatus. The playback section of the on-vehicle video playback apparatus plays back, in a case where contents on the WAN being playback objects based on the playback control information recorded on the video disc are stored by the contents storage section, the stored contents.

According to such a video playback system, the on-vehicle video playback apparatus is configured such that, using the contents obtainment proxy apparatus instead of the playback apparatus, each of the contents on the WAN to be played back can be obtained and stored.

The contents obtainment proxy apparatus is of stationary-type, which allows always-on connection with a WAN at high speed. Thus, the contents obtainment proxy apparatus realizes more reliable and rapid download of contents on a WAN than the on-vehicle video playback apparatus. Therefore, the contents obtainment proxy apparatus enables the on-vehicle video playback apparatus to surely obtain each of the contents on a WAN. As a result, contents on a WAN can be appropriately played back in an improved percentage in a case where a vehicle is outside of an area where the vehicle can be connected to a WAN.

Such a video playback system may be configured to forward the contents stored by the obtainment proxy section to the connected on-vehicle video playback apparatus after performing rate conversion so as to attune the contents to playback rate by the on-vehicle video playback apparatus.

Further, in such a video playback system, the on-vehicle video playback apparatus may have a WAN connection section which is connected to a WAN through radio communication, and a playback section of on-vehicle video playback apparatus may have a download processing section which is connected to the WAN and sequentially downloads and stores each of the contents on the WAN registered in the list in a period when the WAN connection section can be connected to the WAN. The playback section may play back contents on the WAN being playback objects based on the playback control information recorded on the video disc in a case where the contents have already been downloaded and stored by the download processing section or have already been stored by the contents storage section. Further, the contents forwarding section of the contents obtainment proxy apparatus may selectively forward yet-to-be stored contents in the on-vehicle video playback apparatus to the on-vehicle video playback apparatus, from among the contents stored by the obtainment proxy apparatus.

In the above-described on-vehicle video playback apparatus and video playback system, the download processing section may download the contents on the WAN registered in the list in ascending time order to be playback-processed, based on process start timings defined by the playback control information. In a case where a plurality of the contents are to be playback-processed at the same timing based on the process start timings defined by the playback control information, the download processing section may download the contents on the WAN registered in the list in ascending size order.

Measures described above provide improvement in the probability that the contents on the WAN being playback objects in a period when connection with the WAN can not be established have already been stored, which leads to appropriate playback of contents on the WAN.

Further, in the above-described on-vehicle video playback apparatus and video playback system, the download processing section may be configured to preferentially download and store an yet-to-be-stored content on the WAN of which a process start timing defined by the playback control information comes in a period when the WAN connection section can be connected to the WAN, among the other yet-to-be-processed contents on the WAN.

It should be noted that the video disc may be, for example, an HD DVD in which video contents are stored in compliant with an HD DVD-Video standard or a Blu-ray Disc in which video contents are stored in compliant with a BDMV standard.

As described above, the present embodiments realize an on-vehicle video playback apparatus which downloads contents on a WAN like the Internet based on playback control information recorded on a video disc to play back the downloaded contents synchronously with the contents recorded on the video disc, which facilitates appropriate playback of contents on the WAN.

### BRIEF DESCRIPTION OF THE DRAWINGS

FIG. 1 is a block diagram showing the configuration of an on-vehicle DVD player according to one exemplary embodiment.

FIG. 2 exemplifies operation of the on-vehicle DVD player according to one exemplary embodiment.

FIG. 3 shows a network file table according to one exemplary embodiment.

FIG. 4 is a flowchart showing a network file creating process, a network file precedent obtainment process, and a network file provision process which are carried out by the on-vehicle DVD player according to one exemplary embodiment.

FIG. 5 is a flowchart showing a network file proxy obtainment control process which is carried out by the on-vehicle DVD player according to one exemplary embodiment.

FIG. 6 is a flowchart showing a network file proxy obtainment process which is carried out by a personal computer according to one exemplary embodiment.

### DETAILED DESCRIPTION OF THE PREFERRED EMBODIMENTS

Hereinafter, one exemplary embodiment of the video playback apparatus according to the present invention will be described by exemplifying the application to an on-vehicle DVD player for playing back video contents recorded on a DVD.

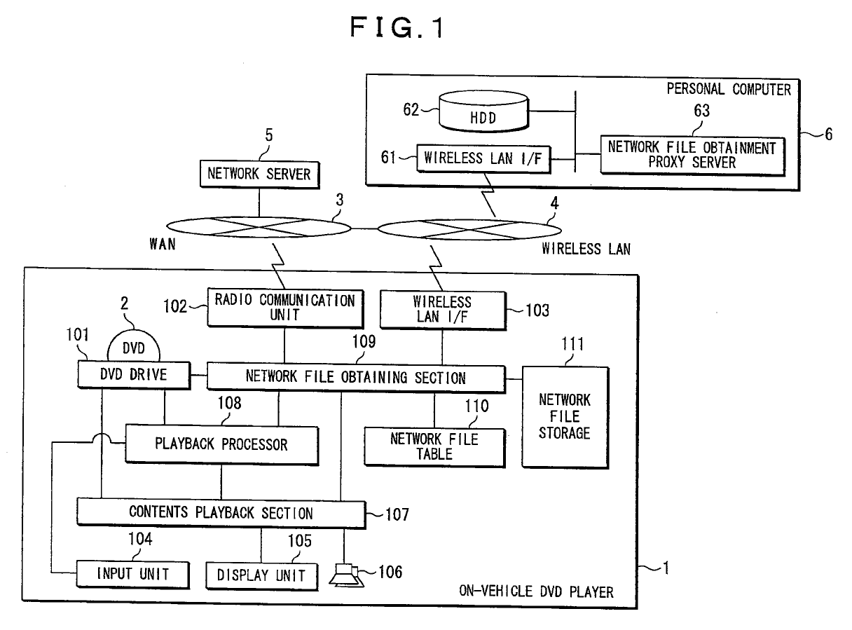

FIG. 1 shows the configuration of an on-vehicle DVD player according to one exemplary embodiment.

As shown in FIG. 1, the on-vehicle DVD player according to the embodiment, which is indicated by a reference numeral 1, is provided with a DVD drive 101 for reading out recorded data of a DVD 2 such as an HD DVD in which video contents are stored in accordance with the HD DVD Video standard and a Blu-ray Disc in which video contents are stored in accordance with the BDMV standard, a radio communication unit 102, a wireless LAN interface 103, an input unit 104, a display unit 105, a speaker 106, a contents playback section 107, a playback processor 108, a network file obtaining section 109, a network file table 110, and a network file storage 111. However, as to hardware, the on-vehicle DVD player 1 may be constituted to have a computer provided with general components, such as a microprocessor, a memory, and the other peripheral devices. Further, in this case, the contents playback section 107 and the network file obtaining section 109 of the on-vehicle DVD player 1 described above may be processes which are realized through execution of a program created in advance by a microprocessor.

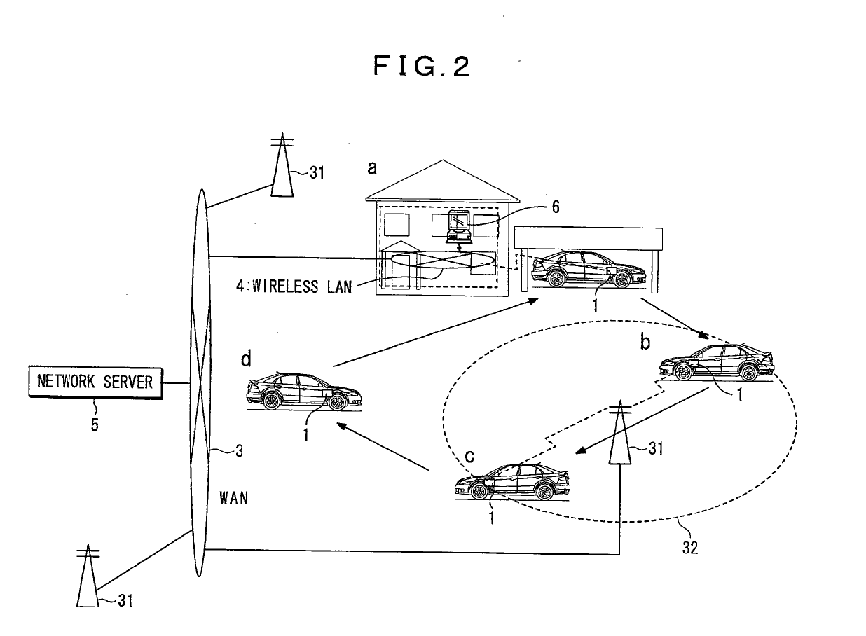

As shown in FIG. 2, the on-vehicle DVD player 1 herein is an apparatus mounted on a vehicle.

As shown in FIGS. 2(b) and (c), when a vehicle on which the on-vehicle DVD player 1 is mounted is in a communication area 32 of a radio base station 31 which relays the communication with a WAN 3 such as the Internet, the radio communication unit 102 is connected to the radio base station 31 through radio communication and connected to the WAN 3 via the radio base station 31.

On the WAN 3, a network server 5 for providing, to the on-vehicle DVD player 1, a file in which contents are to be played back simultaneously with a DVD are stored is arranged. Hereinafter, the file which is supplied from the network server 5 to the on-vehicle DVD player 1 is called a “network file.”

As shown in FIG. 2(a), the wireless LAN interface 103 is, when the vehicle on which the on-vehicle DVD player 1 is mounted is near user's home, connected to a wireless LAN 4 installed in the home through short range radio communication. The WAN 3 and a personal computer 6 which is used by the user at home are connected to the wireless LAN 4, and the personal computer 6 can be connected to the WAN 3 via the wireless LAN 4. The personal computer 6 herein is a computer provided with general components, such as a microprocessor, a memory, and the other peripheral devices. Through execution of a program by the microprocessor, a functional configuration having a wireless interface 61 to be connected to the wireless LAN 4, an HDD 62, and a network file obtainment proxy server 63 is realized on the personal computer 6 as shown in FIG. 1.

In the on-vehicle DVD player 1, the playback processor 108 controls, based on playback control information read out from the DVD 2 through the DVD drive 101 and in accordance with user's operation of the input unit 104, playback of the contents recorded on the DVD 2 and the contents on the WAN 3 stored in a network file. More specifically, the playback processor 108 determines the playback sequence of contents based on the playback control information read out from the DVD 2 through the DVD drive 101 and in accordance with user's operation of the input unit 104, and controls the playback of the contents in the contents playback section 107 recorded on the DVD 2 which is performed based on the determined playback sequence. Further, the playback processor 108 issues, to the network file obtaining section 109, a request for providing a network file on the WAN 3 which has become an playback object based on the determined playback sequence; and controls playback of contents stored in the network file supplied from the network file section in response to the provision request, which is synchronized with playback of the contents recorded on the DVD 2 in the contents playback section 107.

Then, the contents playback section 107 plays back, under control of the playback processor 108, the contents recorded on the DVD 2 and the contents stored in the network file, displays a visual object contained in the contents such as a video or a static image, on the display unit 105, and outputs sound contained in the contents to the speaker 106.

The network file storage 111 stores a network file downloaded from the network server 5.

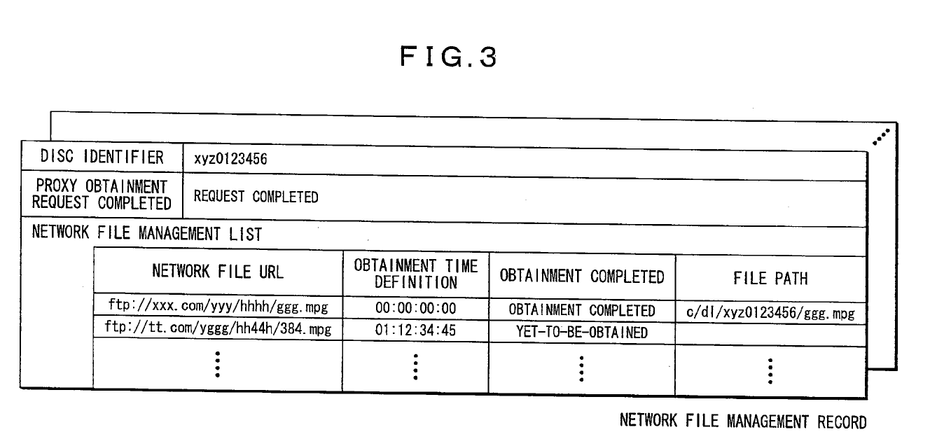

As shown in FIG. 3, a network file management record provided correspondingly to each of the DVDs which have ever been mounted into the on-vehicle DVD player 1 is registered to the network file management table 110 resisters. In addition, each network file management record stores a disc identifier for identifying the corresponding DVD 2, a proxy obtainment request completed flag, and a network file management list.

The network file management list has an entry which is defined in the playback control information of the corresponding DVD 2 and is provided to each of the network files involving possibility to be used when the corresponding DVD 2 is played back by the on-vehicle DVD player 1. To each entry, registered are a network file URL which represents a location of the corresponding network file on the WAN 3, obtainment time definition which represents designated download start time in a case where the designated download start time of the corresponding network file is defined in the playback control information, an obtainment completed flag which shows whether the corresponding network file has already been downloaded, and a file path which represents the downloaded network file recorded in the network file storage 111 in a case where the corresponding network file has already been downloaded.

In such an on-vehicle DVD player 1, for the purposes of obtaining a network file from the WAN 3 and providing a network file which is requested by the playback processor 108, the file obtainment section 109 carries out a network file management record creation process, a network file precedent obtainment process, a network file provision process, and a network file proxy obtainment control process.

These processes will be described.

First, the network file management record creation process will be described.

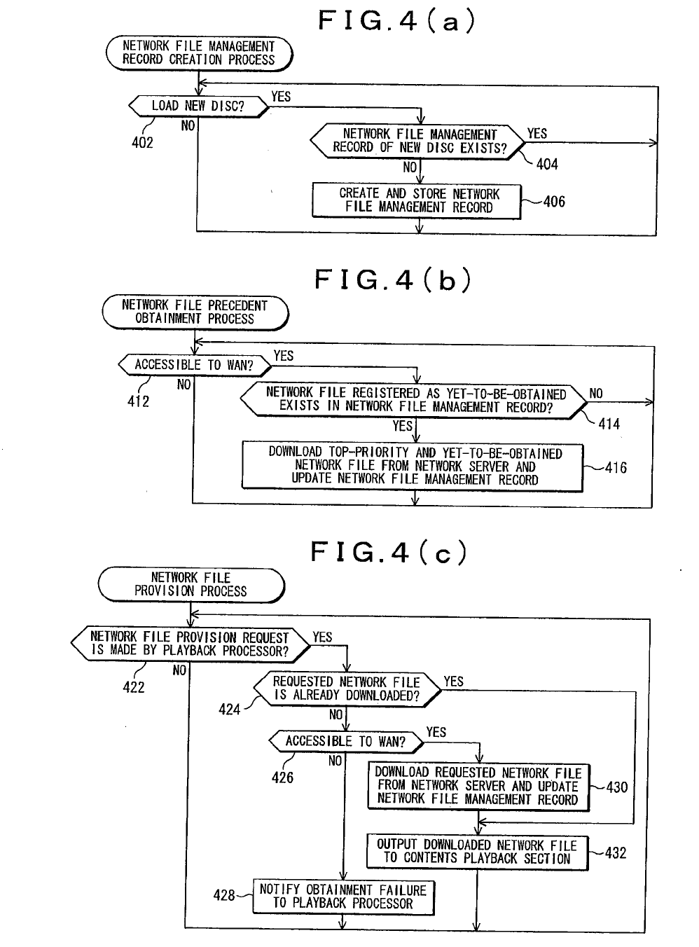

FIG. 4(a) shows a sequence of the network file management record creation process.

As shown in the drawing, in this process, loading of a new DVD 2 into the DVD drive 101 is monitored (Step 402). When a new DVD 2 is mounted, an identifier of the DVD 2 is read out through the DVD drive 101 whether a network file management record in which the identifier read out is registered as a disc identifier has already been registered in the network file table 110 is checked (Step 404). If the network file management record is registered, the program returns to Step 402 so as to perform monitoring. If the network file management record is not registered, a new network file management table corresponding to the mounted DVD 2 is created and registered in the network file table 110 (Step 406). For creating network file management table, an identifier of the mounted DVD 2 is registered in a disc identifier of the created network management table, and “yet-to-be-requested” is registered in the proxy obtainment request completed flag. In the network file management list, provided is an entry defined in the playback control information of the mounted DVD 2, which is read out through the DVD drive 101 and corresponds to each of the network files involving possibility to be used when the mounted DVD 2 is played back. A location of the corresponding network file on the WAN 3 which is described in the playback control information is registered in a network file URL of each entry, and the designated download start time of the corresponding network file defined in the playback control information is registered in the obtainment time definition. “Yet-to-be-obtained” is registered in an obtainment completed flag of each entry.

Hereinbefore, the network file management record creation process was described.

The network file precedent obtainment process will be described.

FIG. 4(b) shows a sequence of the network file precedent obtainment process.

As shown in the drawing, in this process, the network file obtaining section 109 first checks whether connection with the WAN 3 through the radio communication unit 102 can be established at present (Step 412). If it is not, the obtaining section 109 waits until it can.

In a case where connection with the WAN can be established or in a period when connection with the WAN can be established, the network file obtaining section 109 checks whether any entry in which “yet-to-be-obtained” is registered in the obtainment completed flag exists in the network file management list of any one of network file management records of the network file management table (Step 414). If no entry exists, the program returns to Step 412.

In a case where such an entry exists, the network file obtaining section 109 accesses, via the radio communication unit 102 and the WAN 3, a network server 5 which is represented by a server name contained in a network file URL registered in an entry of a top-priority network file among the existing entries. Then, the network file obtaining section 109 downloads a network file specified by the network file URL from the network server 5 and stores the network file in the network file storage 111. Further, a path of the location on the network file storage 111 in which the network file is stored is registered in a file path of the entry of the downloaded network file. An obtainment completed flag of the entry is set to be obtainment completed (Step 416). Then, the program returns to Step 412.

Priority for network files is laid down in accordance with the following rules.

More specifically, a network file which is registered in the network file management list of a network file management record of a DVD 2 being played back is given higher priority than a network file which is registered in the network file management list of a network file management record of another DVD 2.

Further, the priority of a network file registered in the network file management list of a network file management record of a DVD 2 which is mounted is higher than the priority of a network file registered in the network file management list of a network file management record of another DVD 2 which is not mounted.

Further, priority for network files registered in the network file management list of a network file management record of the same DVD 2 is given in ascending time order based on the obtainment time definition (the earlier playback is carried out, the higher priority is given). A network file in which the obtainment time definition is defined is given higher priority than a network file in which the obtainment time definition is not defined.

Further, as to network files which is registered in the network file management list of a network file management record of the same DVD 2, and of which the obtainment time definitions are identical, priority is given in ascending file size order.

The network file precedent obtainment process has been described.

Next, the network file provision process will be described.

FIG. 4(c) shows a sequence of the network file provision process.

As shown in the drawing, in this process, a network file provision request in which a network file URL is designated by the playback processor 108 is monitored (Step 422). When network file provision request is made, whether the network file requested has already been downloaded is checked (Step 424) with reference to an obtainment completed flag of an entry, in which the URL designated by the provision request is registered as a network file URL, in a network file management list of a network file management record of the DVD being played back.

If the requested network file has been downloaded, the downloaded network file is read out from a location of the network file storage 111 represented by a file path of the entry, and is output to the contents playback section 107 (Step 432). Then, the program returns to Step 422 so as to carry out monitoring.

If the network file requested has not been downloaded (Step 424), the network file obtaining section 109 checks whether connection with the WAN 3 through the radio communication unit 102 can be established at present (Step 426). If the connection can not be established, the network obtainment section 109 notifies network file provision failure to the playback processor 108 (Step 428) and the program returns to Step 422 so as to carry out monitoring.

The playback processor 108 which is notified network file provision failure controls playback which is performed by the contents playback section 107 in such a manner that contents of the network file of which notification of the network file provision failure are eliminated from the playback objects.

In a case where it is determined that connection with the WAN 3 can be established at Step 426, the network file obtaining section 109 accesses, via the radio communication unit 102 and the WAN 3, the network server 5 designated by a server name contained in the URL designated, in order to download the network file specified by the URL from the network server 5 and store the network file in the network file storage 111. Further, in a file path of the network file entry, in which the designated URL is registered as a network file URL, in the network file management list of the network file management record of a DVD 2 being played back, a path of the location on the network file storage 111 in which the network file is stored is registered. An obtainment completed flag of the entry is set to be obtainment completed (Step 430).

Then, the network file obtaining section 109 reads out the network file which is downloaded and stored in the network file storage 111 in order to output the network file to the contents playback section 107 (Step 432). The program then returns to Step 422 so as to carry out monitoring.

The network file provision process has been described.

It should be noted that, in a case where download of the network file at Step 416 in the network file precedent obtainment process and download of the network file at Step 430 in the network file provision process are to be carried out coincidentally, the network file obtaining section 109 further performs a process for adjusting the processes, in order to preferentially download the network file at Step 430 in the network file provision process.

The network file proxy obtainment control process will be described.

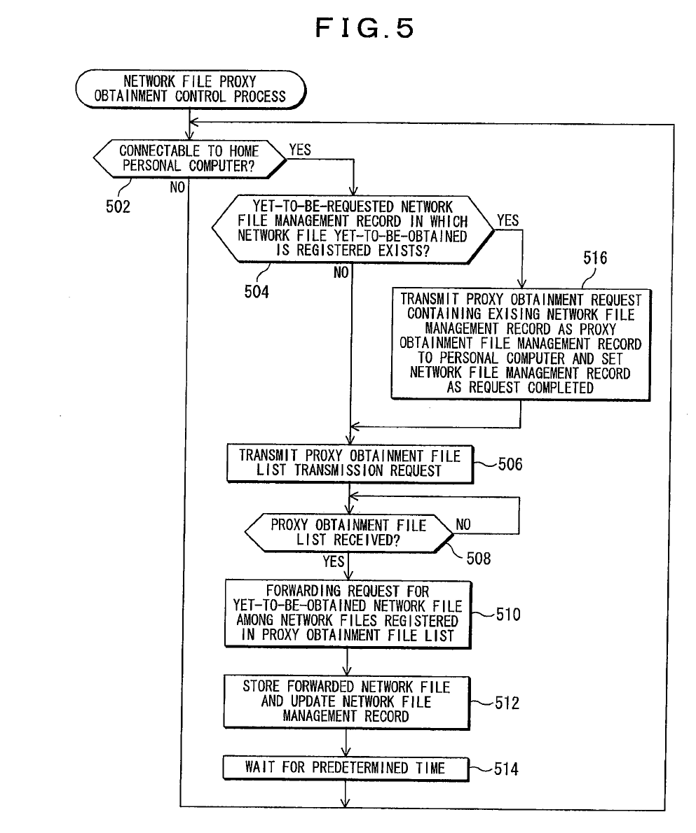

FIG. 5 shows a sequence of the network file proxy obtainment control process.

As shown in the drawing, in this process, the network file obtaining section 109 checks whether connection with the personal computer 6 at user's home through the wireless LAN interface 103 and the wireless LAN 4 can be established (Step 502). If the connection can be established, the network file obtaining section 109 checks whether the request completed flag is set to be “yet-to-be-requested” in the network file table 110 and whether there exists the network file management record in which an entry of which obtainment completed flag is set to be “yet-to-be-obtained” is registered in the network file management list (Step 504). If the network file management record does not exist, the program advances to Step 506.

On the other hand, in a case where such a network file management record exists (Step 504), the network file obtaining section 109 transmits a proxy obtainment request which contains a copy of the existing network file management record as a proxy obtainment file management record to the personal computer 6 via the wireless LAN interface 103 and the wireless LAN 4, and sets the request completed flag to be request completed in the existing file management record (Step 516). Then, the program advances to Step 506.

At Step 506, the network file obtaining section 109 transmits a request for transmitting a proxy obtainment file list to the personal computer 6 via the wireless LAN interface 103 and the wireless LAN 4. When the proxy obtainment file list to be transmitted from the personal computer 6 in reply to a network forwarding request is received (Step 508), a network file which is yet-to-be-obtained is extracted from among network files registered in the received proxy obtainment file list, and a request for forwarding the selected network file is made to the personal computer 6 (Step 510). The proxy obtainment file list which is transmitted from the personal computer 6 is a list of file identifiers of the network file created as file identifiers of individual network files which are a combination of a disc identifier and a network file URL. And at Step 510, in a case where the obtainment completed flag of the entry, in which the network file URL contained in the file identifier is registered, of the network file management list of the network file management record in which a disc identifier contained in a file identifier of each network file registered in the proxy obtainment file list is set to be “yet-to-be-obtained,” the network file obtaining section 109 makes a request to the personal computer 6 for forwarding the network file containing the file identifier of the network file because the network file of the file identifier is yet-to-be-obtained file.

Then, the network file obtaining section 109 stores, in the network file storage 111, the network file which is forwarded from the personal computer 6 in reply to the request for forwarding the network file in such a manner that the file identifier can be identified, and registers a path of the location on the network file storage 111 in which the network file is stored in a file path of the entry, in which a network file URL contained in the file identifier is registered, in the network file management list of the network file management record in which a file identifier of the forwarded network file is registered. The network file obtaining section 109 sets the obtainment completed flag of the entry to be obtainment completed (Step 512).

Then, after predetermined waiting time has elapsed (Step 514), the program returns to a process which starts at Step 502.

The network proxy obtainment control process has been described.

The network file proxy obtainment process which is carried out by the network file obtainment proxy server 63 of the personal computer 6 installed at user's home will be described.

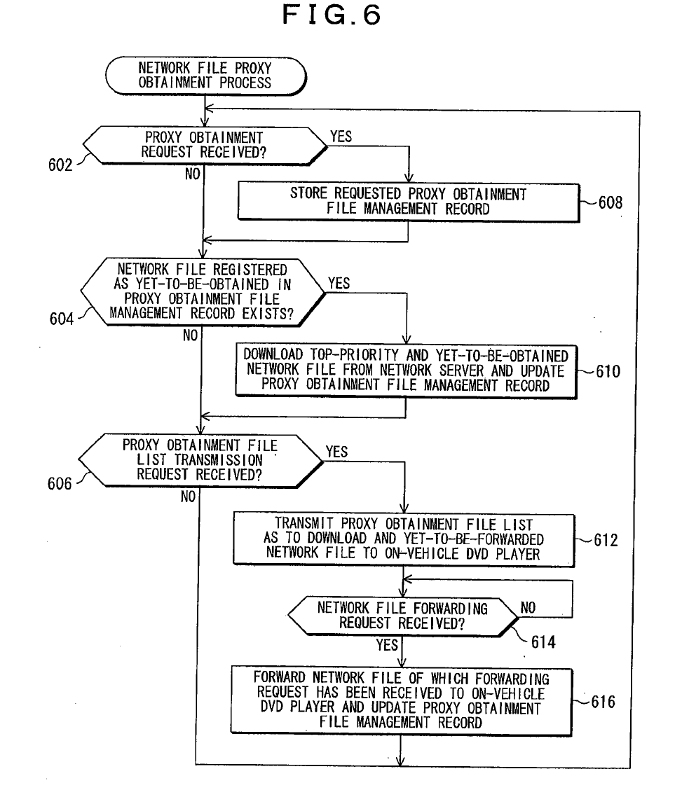

FIG. 6 shows a sequence of the network file proxy obtainment process.

As shown in the drawing, in this process, when a proxy obtainment request transmitted from the on-vehicle DVD player 1 through the wireless LAN 4 is received (Step 602), a proxy obtainment file management record received together with the proxy obtainment request is stored in an HDD 62 (Step 608).

Further, in this process, in a case where an entry in which “yet-to-be-obtained” is registered in the obtainment completed flag exists in the network file management list of any one of the proxy obtainment file management records stored (Step 604), the network file obtaining section 109 accesses, via the wireless LAN 4 and the WAN 3, the network server 5 represented by a server name which is contained in the network file URL registered in the entry of the network file which is given the highest priority on the list of priorities among the existing entries. The network file obtaining section 109 downloads a network file specified by the network file URL from the network server 5 and stores the network file in the HDD 62. The network file obtaining section 109 registers, to a file path of the entry of the downloaded network file, a path of the location on the HDD 62 in which the network file is stored. The network file obtaining section 109 sets the obtainment completed flag of the entry of the proxy obtainment file management record to be proxy obtainment completed (Step 610).

Further, in this process, when the network file obtaining section 109 receives a request for transmitting a proxy obtainment file list from the on-vehicle DVD player 1 via the wireless LAN 4 (Step 606), the network file obtaining section 109 generates, for each entry in which completion of proxy obtainment is registered in the obtainment completed flag of the network file management list of each proxy obtainment file management record, a file identifier consists of a combination of a disc identifier of the proxy obtainment file management record to which the entry belongs and a network file URL registered in the entry. The network file obtaining section 109 creates a proxy obtainment file list containing each generated file identifier and transmits the proxy obtainment file to the on-vehicle DVD player 1 (Step 612). When the network file obtaining section 109 receives a request for forwarding a network file from the on-vehicle DVD player 1 via the wireless LAN 4 (Step 614), the network file obtaining section 109 reads out a network file from a location of the HDD 62 represented by a file path of the entry, in which the network file URL contained in the file identifier is registered, in the network file management list of the proxy obtainment file management record in which the disc identifier contained in each file identifier contained in the request. Then, the network file obtaining section 109 forwards the network file to the on-vehicle DVD player 1 in such a manner that the file identifier of each network file can be identified and can be set to be obtainment completed, the obtainment completed flag of the entry of the network file management list of each proxy obtainment file management record corresponding to all the file identifiers contained in the obtainment file list which has been previously transmitted (Step 616). It is preferable that, when a network file is transmitted to the on-vehicle DVD player 1 at Step 616, in a case where the network file is high-resolution video data and the like, the video data is forwarded to the on-vehicle DVD player 1 after converting the video data image quality into that of playback in the on-vehicle DVD player 1.

The network file proxy obtainment process to be carried out by the network file obtainment proxy server 63 of the personal computer 6 has been described.

Operation of such an on-vehicle DVD player 1 will be exemplary shown.

If a user loads a DVD 2 into the on-vehicle DVD player 1 in a state that the vehicle is, for example, in user's garage where the on-vehicle DVD player 1 can be connected to a wireless LAN 4 installed at user's home as shown in FIG. 2(a), a network file management record in which a network file to be used at the time of playback of the DVD 2 is registered is created through the network file management record creation process in the on-vehicle DVD player 1; and a copy of the network file management record is transmitted as a proxy obtainment file management record to the personal computer 6 via the wireless LAN 4 through the network file proxy obtainment control process. The proxy obtainment file management record is stored in the personal computer 6 through the network file proxy obtainment process.

When the vehicle then moves as shown in FIGS. 2(b), (c), and (d), in a period when connection with the WAN 3 through the radio base station 31 shown in FIGS. 2(b) and (c) can be established, each of the network files registered in the network file management record is downloaded from the network server 5 and stored one by one through the network file precedent obtainment process, regardless of whether the DVD 2 is being played back or not and regardless of network file downloading start definition time. Further, through the network file provision process, a network file which has become a playback object is provided to the contents playback section 107 so as to be played back. In a case where the network file being a playback object has already been downloaded and stored, the stored network file is provided to the contents playback section 107. In a case where the network file being a playback object has not been downloaded, the network file is downloaded from the network server 5 and then provided to the contents playback section 107 through the network file provision process.

In case the vehicle then moves to an area shown in FIG. 3(d) where the connection with the WAN 3 can not be established and a new network file becomes a playback object when the vehicle is traveling in the area, through the network file provision process, whether the network file has been downloaded and stored is determined. If the network file has already been stored, the stored network file is provided to the contents playback section 107 so as to be played back.

When the vehicle is traveling outside of user's house, through the network file proxy obtainment process, each network file registered in the proxy obtainment file management record received from the on-vehicle DVD player 1 is downloaded from the network server 5 via the wireless LAN 4 and the WAN 3 and stored in the personal computer 6.

When the vehicle returns to user's garage as shown in FIG. 2(a) and it comes to the state where connection between the on-vehicle DVD player 1 and the wireless LAN 4 can be established, a network file not stored in the on-vehicle DVD player 1 from among network files which have already been downloaded from the network server 5 through the network file proxy obtainment process of the personal computer 6 is forwarded to the on-vehicle DVD player 1 from the personal computer 6, and stored in the on-vehicle DVD player 1 through the network file proxy obtainment control process of the on-vehicle DVD player 1 and the network file proxy obtainment process of the personal computer 6. And the stored network file is used when the DVD 2 is played back subsequently.

The exemplary embodiment has been described.

According to the exemplary embodiment as just described, in the on-vehicle DVD player 1, each network file on the WAN 3 which involves possibility to be played back at the time of playback of a video disc can be downloaded from the server 5 and stored one by one in advance, in a period when the connection with the WAN 3 can be established, regardless of whether the contents are being played back or not and regardless of the process start timing. Therefore, even in a period when the on-vehicle DVD player 1 cannot be connected to the WAN 3, appropriate playback each of the stored network files is realized by means of the network file stored in advance. Consequently, even when the vehicle is outside of an area where the connection with the WAN 3 can be established, appropriate play back of the contents on the WAN 3 is realized in an improved percentage.

Further, according to the embodiment, the on-vehicle DVD player 1 is configured such that the personal computer 6 provided at user's home carries out, for the on-vehicle DVD player 1, off-line download of respective network files on the WAN 3 which involves possibility to be played back at the time of playback of a video disc, in order to acquire and store the network files on the WAN 3. Accordingly, playback of the network files on the WAN 3 is realized by utilizing the stored network file.

The personal computer 6 is installed in a stationary-type device, and therefore the personal computer 6 can be a device capable of connecting with the WAN 3 at high speed on a steady basis. Thus, the personal computer 6 is capable of downloading network files on the WAN 3 more reliably and at faster speed than the on-vehicle DVD player 1. Thus, in the on-vehicle DVD player, each of the network files on the WAN can be surely obtained by means of the personal computer 6. As a result, appropriate play back of contents on the WAN is realized in an improved possibility even when the vehicle is outside of an area where connection to the WAN can be established.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

1. An on-vehicle video playback apparatus for playing back a video disc, the on-vehicle video playback apparatus comprising:
a WAN connection section that is connected to a WAN through radio communication, and
a playback section configured to play back contents on the WAN together with contents recorded on the video disc based on playback control information recorded on the video disc, wherein:
the playback section comprises:
an on-WAN contents list creation section configured to create, at a time of loading the video disc, a list of which contents on the WAN to be played back by the playback section at a time of video disc playback based on the playback control information recorded on the video disc are registered, and
a download processing section that is connected to the WAN during a period in which the WAN connection section can be connected to the WAN, and sequentially downloads and stores each of the contents on the WAN identified in the list; and
when the contents have already been downloaded and stored by the download processing section, the playback section plays back contents on the WAN that are playback objects based on the playback control information recorded on the video disc.

2. The on-vehicle video playback apparatus according to claim 1, wherein the download processing section downloads the contents on the WAN identified in the list in ascending time order to be playback-processed, based on process start timings defined by the playback control information.

3. The on-vehicle video playback apparatus according to claim 2, wherein the download processing section downloads the contents on the WAN identified in the list in ascending size order based on the process start timings defined by the playback control information when a plurality of the contents are to be playback-processed at the same timing.

4. The on-vehicle video playback apparatus according to claim 1, wherein the download processing section preferentially downloads and stores an yet-to-be-stored content on the WAN of which a process start timing defined by the playback control information comes during a period in which the WAN connection section can be connected to the WAN, among the other yet-to-be-processed contents on the WAN.

5. The on-vehicle video playback apparatus according to claim 1, wherein the video disc is an HD DVD in which video contents are stored in compliant with an HD DVD-Video standard or a Blu-ray Disc in which video contents are stored in compliant with a BDMV standard.

6. An on-vehicle video playback system comprising an on-vehicle video playback apparatus for playing back a video disc and a stationary-type contents obtainment proxy apparatus which can be connected to a WAN, wherein:
the on-vehicle video playback apparatus comprises:
a short range radio communication section that is connected to the contents obtainment proxy apparatus through short range radio communication, and
a playback section configured to play back contents on the WAN together with contents recorded on the video disc based on playback control information recorded on the video disc;
the playback section comprises:
an on-WAN contents list creation section configured to create, at a time of loading the video disc, a list in which contents on the WAN to be played back by the playback section at a time of video disc playback based on the playback control information recorded on the video disc are registered,
an obtainment requesting proxy section that is connected to the contents obtainment proxy apparatus and transmits to the contents obtainment proxy apparatus a proxy obtainment request for contents on the WAN identified by the list, during a period in which the short range radio communication section can be connected to the contents obtainment proxy apparatus, and
a contents storage section, that is connected to the contents obtainment proxy apparatus, configured to receive and store contents on the WAN obtained and forwarded by the contents obtainment proxy apparatus, during a period in which the short range radio communication section can be connected to the contents obtainment proxy apparatus; and
the contents obtainment proxy apparatus comprises:
an obtainment proxy section configured to sequentially download and store contents on the WAN identified in the list along with the proxy obtainment request from the connected on-vehicle video playback apparatus,
a contents forwarding section configured to forward contents stored by the obtainment proxy section to the connected on-vehicle video playback apparatus, and
when contents on the WAN that are playback objects based on the playback control information recorded on the video disc are stored by the contents storage section, the playback section of the on-vehicle video playback apparatus plays back the stored contents.

7. The video playback system according to claim 6, wherein the contents forwarding section of the contents obtainment proxy apparatus forwards the contents stored by the obtainment proxy section to the connected on-vehicle video playback apparatus after performing rate conversion so as to attune the contents to a playback rate by the on-vehicle video playback apparatus.

8. The video playback system according to claim 6, wherein
the on-vehicle video playback apparatus has a WAN connection section that is connected to a WAN through radio communication, and
a playback section of on-vehicle video playback apparatus has a download processing section that is connected to the WAN and sequentially downloads and stores each of the contents on the WAN identified in the list during a period in which the WAN connection section can be connected to the WAN, and
the playback section plays back contents on the WAN that are playback objects based on the playback control information recorded on the video disc when the contents have already been downloaded and stored by the download processing section or have already been stored by the contents storage section.

9. The video playback system according to claim 8, wherein the contents forwarding section of the contents obtainment proxy apparatus selectively forwards yet-to-be stored contents in the on-vehicle video playback apparatus to the on-vehicle video playback apparatus, from among the contents stored by the obtainment proxy apparatus.

10. The video playback system according to claim 8, wherein the download processing section downloads the contents on the WAN registered in the list in ascending time order to be playback-processed, based on process start timings defined by the playback control information.

11. The video playback system according to claim 10, wherein the download processing section downloads the contents on the WAN registered in the list in ascending size order, when a plurality of the contents are to be playback-processed at the same timing based on the process start timings defined by the playback control information.

12. The video playback system according to claim 8, wherein the download processing section preferentially downloads and stores an yet-to-be-stored content on the WAN of which a process start timing defined by the playback control information comes during a period in which the WAN connection section can be connected to the WAN, among the other yet-to-be-processed contents on the WAN.

13. The video playback system according to claim 6, wherein the video disc is an HD DVD in which video contents are stored in compliant with an HD DVD-Video standard or a Blu-ray Disc in which video contents are stored in compliant with a BDMV standard.

14. A video playback method for on-vehicle video playback apparatus for playing back contents on a WAN together with contents recorded on a video disc based on playback control information recorded on the video disc, the method comprising:
a step for creating an on-WAN contents list at a time of loading the video disc of which contents on the WAN to be played back by the playback section at a time of video disc playback based on the playback control information recorded on the video disc are registered;
a step for precedent download in which each of the contents on the WAN identified in the list is precedently and sequentially downloaded and stored, through connection establishment during a period in which the WAN can be connected; and
a step for playing back contents on the WAN that are playback objects based on the playback control information recorded on the video disc when the contents have already been downloaded and stored by the download processing section.

15. The video playback method according to claim 14, wherein, in the step for precedent download, the contents on the WAN identified in the list are downloaded in ascending time order to be playback-processed, based on process start timings defined by the playback control information.

16. The video playback method according to claim 15, wherein, in the step for precedent download, the contents on the WAN identified in the list are downloaded in ascending size order, when a plurality of the contents are to be playback-processed at the same timing based on the process start timings defined by the playback control information.

17. A computer program which is read out and carried out by an on-vehicle computer, the computer program causing the computer to serve as:
a WAN connection section that is connected to a WAN through radio communication, and
a playback section configured to play back contents on the WAN together with contents recorded on an on-vehicle video disc based on playback control information recorded on the video disc, wherein:
the playback section comprises:
an on-WAN contents list creation section configured to create, at a time of loading the video disc, a list of which contents on the WAN to be played back by the playback section at a time of video disc playback based on the playback control information recorded on the video disc are registered, and
a download processing section that is connected to the WAN during a period in which the WAN connection section can be connected to the WAN and sequentially downloads and stores each of the contents on the WAN identified in the list; and
when the contents have already been downloaded and stored by the download processing section, the playback section plays back contents on the WAN that are playback objects based on the playback control information recorded on the video disc.

18. The computer program according to claim 17, wherein the download processing section downloads the contents on the WAN identified in the list in ascending time order to be playback-processed, based on process start timings defined by the playback control information.

19. The computer program according to claim 18, wherein the download processing section downloads the contents on the WAN identified in the list in ascending size order, in a case where a plurality of the contents are to be playback-processed at the same timing based on the process start timings defined by the playback control information.

20. The computer program according to claim 17, wherein the download processing section preferentially downloads and stores an yet-to-be-stored content on the WAN of which a process start timing defined by the playback control information comes during a period in which the WAN connection section can be connected to the WAN, among the other yet-to-be-processed contents on the WAN.
